(19) United States
(12) Patent Application Publication
(10) Pub. No.: US 2007/0062462 A1
(43) Pub. Date: Mar. 22, 2007

(54) Animal noise protector

(76) Inventor: Michele McGuire, Westminster, MD (US)

Correspondence Address: JOHN ALEXANDER GALBREATH, 2516 CHESTNUT WOODS CT, REISTERSTOWN, MD, 21136, US

(21) Appl. No.: 11/232,671

(22) Filed: Sep. 22, 2005

(51) Int. Cl. A01K 13/00

(52) U.S. Cl. 119/850

(57) ABSTRACT

An animal noise protector is disclosed, suitable for placement on the animal's head, over the ears. Two noise-blocking members, suitably sized so as fit comfortably and snugly over the animal's ears and against the sides of the animal's head, are joined by at least one connecting strap that is easily adjustable via hook or loop material located on the noise-blocking members. An adjustable neck strap also connects the noise-blocking members.

### BACKGROUND

1. Field of the Invention

The invention is in the area of animal noise protectors.

2. Description of the Related Art

Ear coverings for animals are known in the art; however, most of these are not capable of hearing/noise protection, but instead are designed to protect the outer ear flap, keep out insects, keep the ears out of the animal's food, cover an ear wound, or keep the ear warm. The physical structure of these devices, and their ability to block noise, is thus markedly different from that of the invention.

U.S. Pat. No. D417,315 to Lowry shows a protective ear covering that uses two ear pockets separated by a strap across the top of a dog's head. However, the ear pockets are made of a mesh material having a grid-like appearance, which will not block sound. Moreover, Lowry's strap is not easily adjustable via hook and loop (Velcro) attachment points.

U.S. Pat. No. 5,163,272 to Finley; U.S. Pat. No. 4,233,942 to Williams; and U.S. Pat. No. 4,964,264 to Adams all show dog ear protectors. However, these are designed to either block insects from entering the ear canal or prevent the dog's ears from becoming soiled by food while eating. Accordingly, the physical structures of these devices are significantly different than that of the invention, and none of them will serve to protect the dog from bothersome noises. These devices also lack important elements of the physical structure of the invention—e.g., the adjustable hook and loop straps that hold the invention on the animal's head.

U.S. Pat. No. 6,502,532 to Sjolin discloses an animal bandage device that fits over the ears; however, this device does not cover the ears and thus will not block noise.

U.S. Pat. No. 5,540,189 to Masson and U.S. Pat. No. 5,456,215 to Deutscher show cattle ear covers which are designed to keep the animal's ears warm. Deutscher's device is a whole-head cover which differs markedly in structure from the invention. Masson's device would not adequately block out noise, because the bottom of the ear covers do not seal tightly against the animal's head. Further, Masson's device adjusts in a very different manner than the invention—it does not have hook and loop material directly on the ear covers to allow fast and easy adjustment as in the invention.

U.S. Pat. No. 3,942,306 to Kulka discloses various animal noise protection devices. However, the head band shown in this patent differs markedly in structure from the invention.

### SUMMARY OF THE INVENTION

The invention is an animal noise protector that is placed on the animal's head, over the ears. Two noise-blocking members, suitably sized so as fit comfortably and snugly over the animal's ears and against the sides of the animal's head, are joined by at least one connecting strap that is easily adjustable via hook or loop material located on the noise-blocking members. An adjustable neck strap is also attached between the noise-blocking members.

Several objects and advantages of the invention are:

It is an object of the invention to provide an easy-to-install animal noise protector that will effectively block undesirable noise from reaching an animal's ears, thereby preventing the animal from being distracted, fearful, or even in pain due to the noise.

It is a further object of the invention to provide a device that can be worn by many different animals, including but not limited to pets, farm animals, etc.

It is a further object of the invention to provide a device that can be quickly and easily adjusted to optimally fit the animal's head, so that the animal will be comfortable wearing it.

It is a further object of the invention to provide a device that has a relatively simple construction, and a relatively low cost.

Further objects and advantages of the invention will become apparent from a consideration of the ensuing description and drawings.

### DESCRIPTION OF THE DRAWINGS

FIG. 1 is a perspective view of the animal noise protector, illustrating the ear covers and connecting straps.

FIG. 2 further illustrates an ear cover and the hook attachment patches located thereon.

FIG. 3 further illustrates a connecting strap and the loop attachment patches located thereon. For clarity and convenience, the full length of the connecting strap is not shown.

FIG. 4 is a side view of the animal noise protector installed on an animal.

FIG. 5 illustrates an alternative embodiment, wherein the entire connecting strap is made of loop material. For clarity and convenience, the full length of the connecting strap is not shown.

FIG. 6 illustrates an alternative embodiment, wherein the neck strap has a buckle located between its two ends. For clarity and convenience, the full length of the connecting strap is not shown.

### DETAILED DESCRIPTION OF THE INVENTION

The following provides a list of the reference characters used in the drawings:
10. First ear cover
11. Second ear cover
12. Foam ring
13. First connecting strap
14. Second connecting strap
15. Neck strap
16. Hook material
17. Loop material
18. Buckle

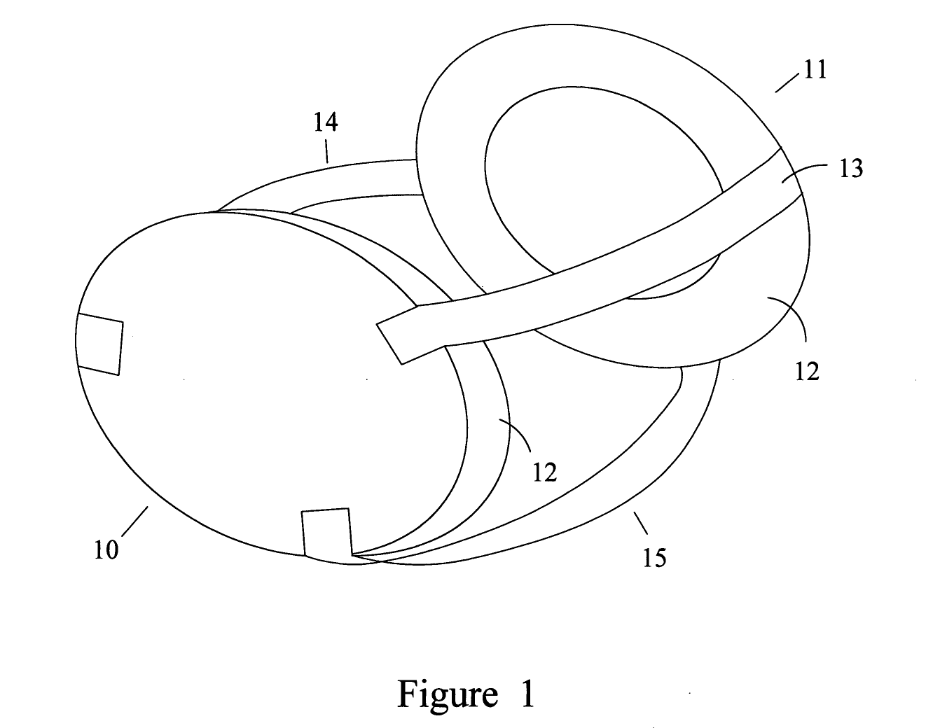

As shown in FIG. 1, the invention comprises a first ear cover 10 and a second ear cover 11. First ear cover 10 and second ear cover 11 are connected by a first connecting strap 13, a second connecting strap 14, and a neck strap 15. First ear cover 10 and a second ear cover 11 are constructed of a substantially rigid noise-blocking material formed in a shell shape, and have a foam ring 12 around the inner periphery thereof. Foam ring 12, together with the shell shape of first ear cover 10 and second ear cover 11, form cavities on the inner (head-contacting) sides of the device, and the animal's ears fits into these cavities when the device is on the animal's head. Foam ring 12 compresses against the animal's head, and the shell/foam ring construction effectively blocks undesirable sound from entering the animal's ears.

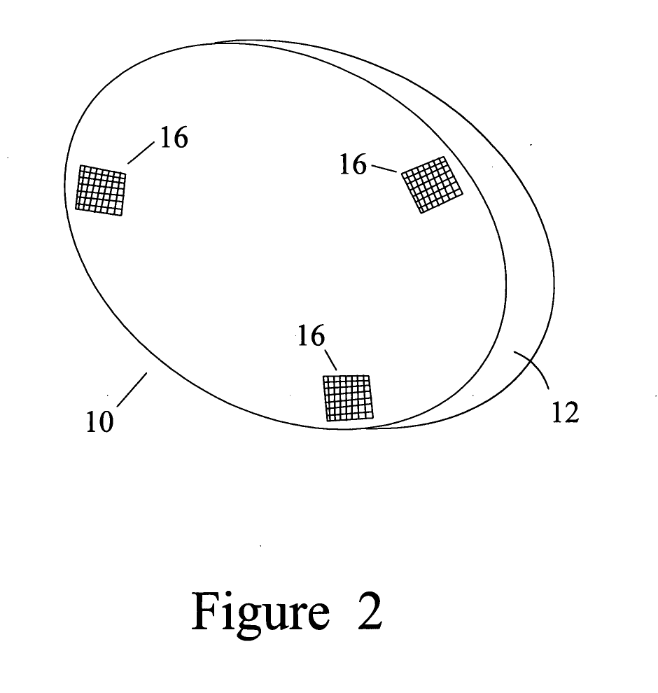

FIG. 2 further illustrates first ear cover 10, which has three patches of hook material 16 located thereon. Hook material 16 comprises one half of the mating attachment material commonly referred to by the trade name Velcro®. It should be understood that second ear cover 11 also has three patches of hook material 16 located thereon, and that a mirror image of FIG. 2 would generally illustrate the position of the patches of hook material 16 on second ear cover 11. Referring back to FIG. 1, it can be appreciated that these patches of hook material 16 are covered by, and attach to, the ends of first connecting strap 13, second connecting strap 14, and neck strap 15.

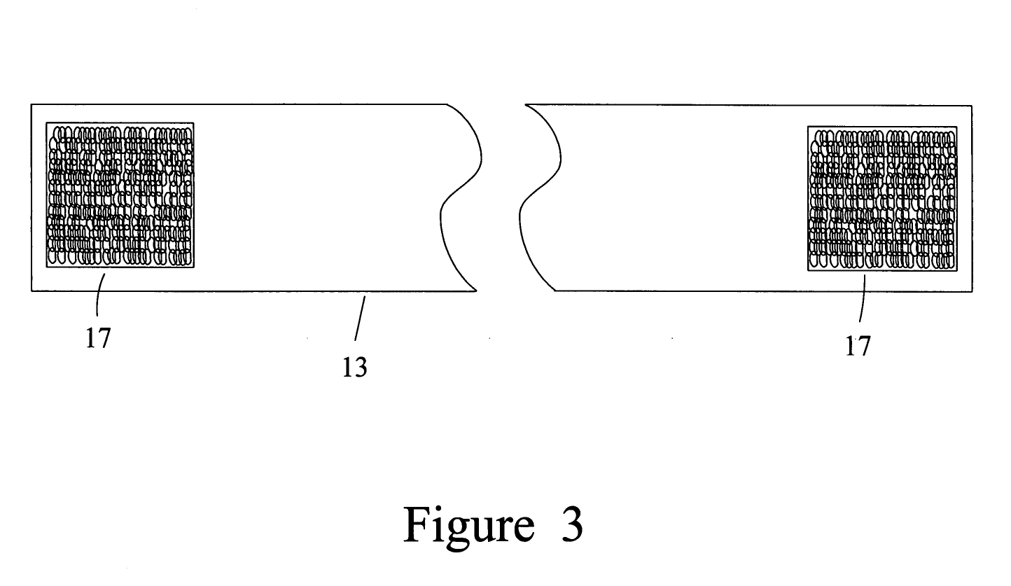

FIG. 3 is a view of the bottom (hook-material-contacting) surface of first connecting strap 13. First connecting strap 13 has a patch of loop material 17 located at each end thereof. Loop material 17 comprises the other half of the mating attachment material commonly referred to by the trade name Velcro®. It is these patches of loop material 17 that mate with the patches of hook material 16 on first ear cover 10 and second ear cover 11. It should be understood that although for specificity the connecting strap shown in FIG. 3 is labeled as first connecting strap 13, it can also represent second connecting strap 14 and/or neck strap 15. The main bodies of first connecting strap 13, second connecting strap 14, and neck strap 15 are made from elastic material, such that they are able to stretch along their length and provide a further degree of adaptability of the device to differently sized and shaped animal heads.

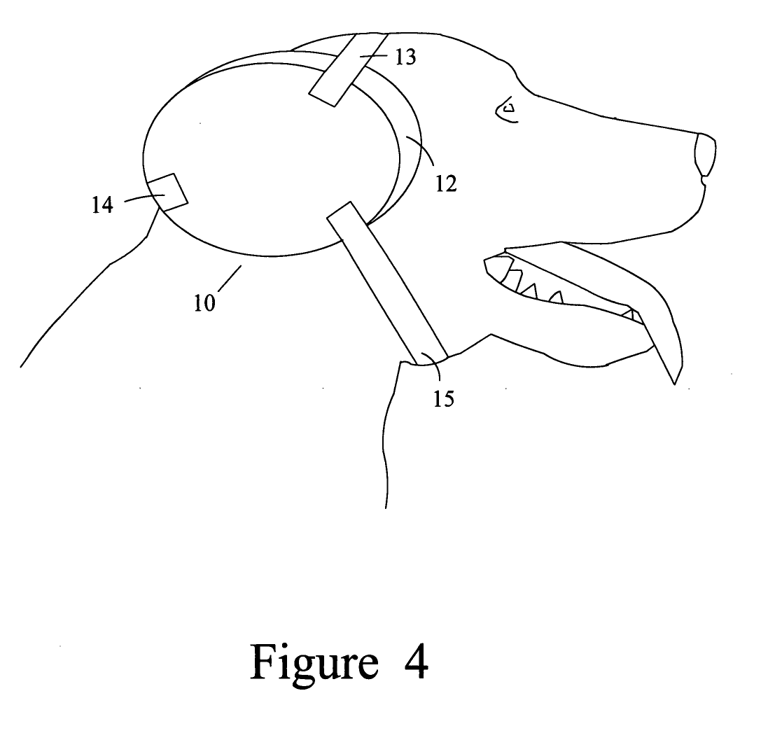

FIG. 4 is a side view of the animal noise protector installed on an animal, here a dog. First connecting strap 13 is positioned substantially across the top of the animal's head, second connecting strap 14 is positioned substantially across the back of the animal's head, and neck strap 15 is positioned substantially across the front of the animal's neck, under the chin.

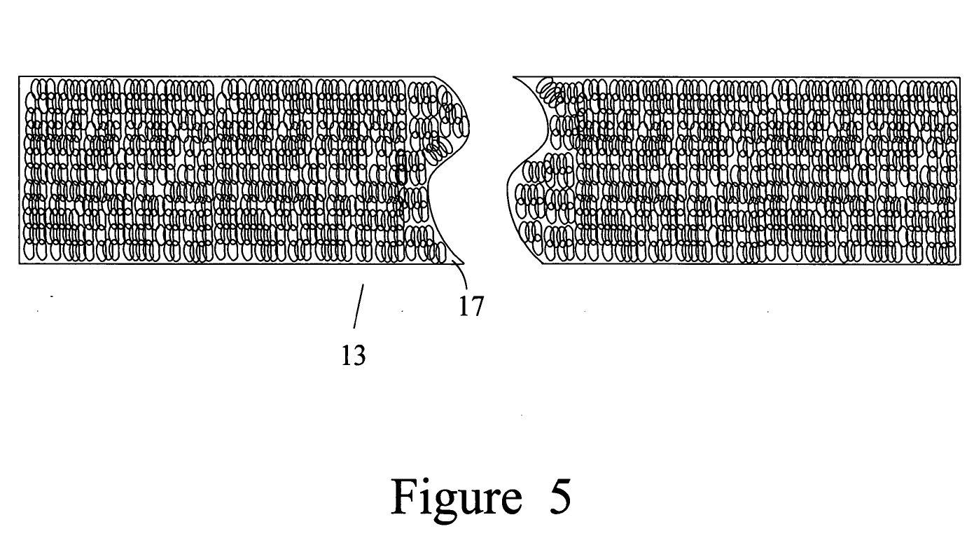

FIG. 5 shows an alternative embodiment, wherein the bottom (hook-material-contacting) surface of first connecting strap 13 is made completely of loop material 17. In this embodiment, first connecting strap 13 is essentially a strip of loop material 17. This allows for a greater degree of adjustment of the device on the animal's head than is allowed by patches of loop material merely on the ends of first connecting strap 13. It should be understood that although for specificity the connecting strap shown in FIG. 5 is labeled as first connecting strap 13, it can also represent an alternative embodiment of second connecting strap 14 or neck strap 15, with loop material located over the length of the strap.

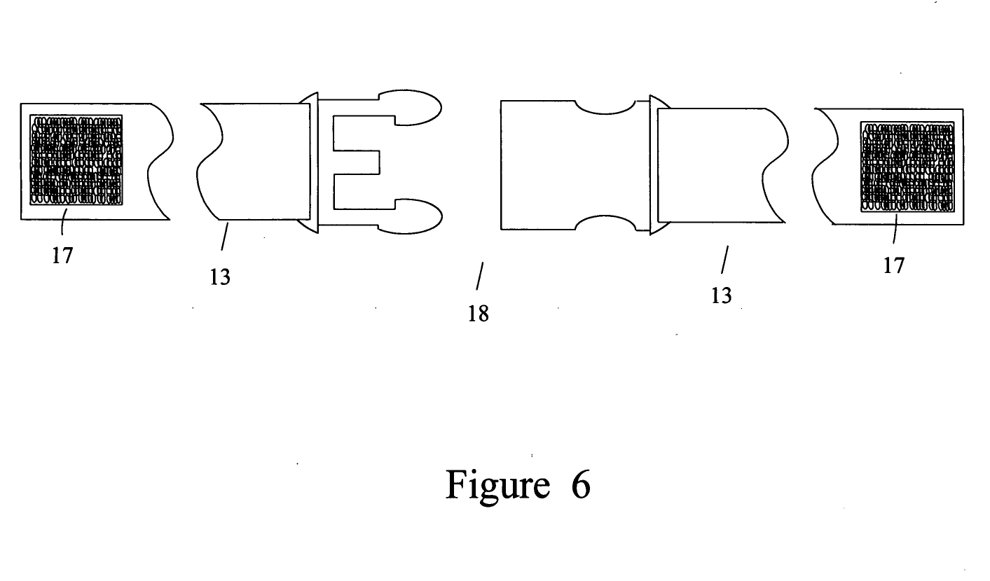

FIG. 6 shows another alternative embodiment, wherein neck strap 15 has a buckle 18 located between its two ends. Buckle 18 allows for easier connection and disconnection of neck strap 15 once the basic fit of neck strap 15 on the animal—that is, neck strap 15's connection to first ear cover 10 and second ear cover 11—has been established. It also allows for connection and disconnection of neck strap 15 in versions where the ends of neck strap 15 are permanently and non-adjustably attached to first ear cover 10 and second ear cover 11.

While the above descriptions contain many specificities, these shall not be construed as limitations on the scope of the invention, but rather as exemplifications of embodiments thereof. Many other variations are possible without departing from the spirit of the invention. Examples of just a few of the possible variations follow:

The patches of hook material on the ear covers can instead be patches of loop material.

Correspondingly, the connecting straps and neck strap can have patches of hook material on their ends instead of patches of loop material. In an alternative embodiment used with the above variant, the connecting strap or neck strap could have hook material along its length rather than just patches (i.e, FIG. 5 but with hook material instead of loop material).

The adjustability of the device can be only on one side—i.e., on one ear cover. In such an embodiment, the connecting straps would be permanently/non-adjustably attached to one ear cover, while the other ear cover would have the patches of hook or loop material that allow for removable attachment. Alternatively, both ends of the connecting straps and/or neck strap can be permanently attached to the ear covers. In this variant, the elasticity of the strap material would provide the necessary flexibility in placing the device on the animal's head.

The location of the hook or loop patches on the ear covers, and thus the position of the connecting straps around the animal's head, can be different than that shown. The number of connecting straps can also be different than that shown.

The size and shape of the hook or loop patches on the ear covers can be different than that show. By way of non-limiting example, the patches could be circular, oval, rectangular, or any other suitable shape. In fact, a portion of the ear cover, or the entire ear cover, could be sheathed in hook or loop material, which would increase the degree of adjustability of the connecting straps about the animal's head.

The neck strap, although referred to separately from the other connecting straps, can also of course be considered to be a “connecting strap” since it connects the two ear covers as well.

The strap material may be non-elastic, versus the elastic material described and shown in the various figures.

The ear cover construction may be different than the substantially rigid shell with foam ring construction described and shown in the various figures. Al that is required is that the ear cover material be suitably noise-blocking. The foam ring can be of different material, although some degree of compressibility is desired for optimal noise-blocking. The foam ring can also be eliminated, as long as the ear cover material is sufficiently flexible to conform to the animal's head around the ear area.

The size, shape, depth, and other dimensions of the ear covers can vary, to fit ears of different animals or animals of different sizes.

Accordingly, the scope of the invention should be determined not by the embodiments illustrated, but by the appended claims and their legal equivalents.

What is claimed is:

1. An animal noise protector, comprising:
(a) means for blocking noise, said means comprising two noise-blocking ear covers;
(b) a plurality of connecting straps connecting said ear covers together;
(c) releasable fastening means to detachably attach at least one of said connecting straps to at least one of said ear covers, a first part of said releasable fastening means being located on said at least one connecting strap and a corresponding second part of said releasable fastening means being located on said at least one ear cover;
whereby said animal noise protector can be quickly and easily installed on and removed from an animal.

2. The animal noise protector of claim 1, wherein three connecting straps connect said ear covers together.

3. The animal noise protector of claim 2, wherein said releasable fastening means detachably attach said three connecting straps to said at least one ear cover.

4. The animal noise protector of claim 3, wherein said releasable fastening means detachably attach said three connecting straps to each of said ear covers.

5. The animal noise protector of claim 3, wherein said releasable fastening means comprise hook and loop fasteners, and said hook fasteners are located on said at least one ear cover and said loop fasteners are located on said three connecting straps.

6. The animal noise protector of claim 1, wherein said releasable fastening means comprise hook and loop fasteners.

7. The animal noise protector of claim 6, wherein a hook fastener is located on said at least one ear cover and a loop fastener is located on said at least one connecting strap.

8. The animal noise protector of claim 1, wherein said releasable fastening means extend substantially along the lengthwise dimension of at least one of said connecting straps.

9. The animal noise protector of claim 1, wherein said animal noise protector also comprises a buckle located on at least one of said connecting straps.

10. The animal noise protector of claim 1, wherein said animal noise protector also comprises a ring of compressible material that substantially surrounds the periphery of an ear-proximate side of at least one of said ear covers.

11. An animal noise protector, comprising:
(a) means for blocking noise, said means comprising two noise-blocking ear covers;
(b) at least one connecting strap connecting said ear covers together;
(c) corresponding male and female members to detachably attach said at least one connecting strap to at least one of said ear covers;
whereby said animal noise protector can be quickly and easily installed on and removed from an animal.

12. The animal noise protector of claim 11, wherein three connecting straps connect said ear covers together.

13. The animal noise protector of claim 12, wherein said corresponding male and female members detachably attach said three connecting straps to said at least one ear cover.

14. The animal noise protector of claim 13, wherein said corresponding male and female members detachably attach said three connecting straps to each of said ear covers.

15. The animal noise protector of claim 13, wherein said corresponding male and female members comprise hook and loop fasteners, and said hook fasteners are located on said at least one ear cover and said loop fasteners are located on said three connecting straps.

16. The animal noise protector of claim 11, wherein said corresponding male and female members comprise hook and loop fasteners.

17. The animal noise protector of claim 16, wherein a hook fastener is located on said at least one ear cover and a loop fastener is located on said at least one connecting strap.

18. The animal noise protector of claim 16, wherein a loop fastener extends substantially along the lengthwise dimension of said at least one connecting strap.

19. The animal noise protector of claim 11, wherein said animal noise protector also comprises a buckle located on said at least one connecting strap.

20. The animal noise protector of claim 11, wherein said animal noise protector also comprises a ring of compressible material that substantially surrounds the periphery of an ear-proximate side of at least one of said ear covers.
